(19) United States
(12) Patent Application Publication
(10) Pub. No.: US 2022/0241879 A1
(43) Pub. Date: Aug. 4, 2022

(54) Tool and Method for Creating Back Tapers at the Teeth of a Toothing of a Gear

(71) Applicant: Präwema Antriebstechnik GmbH, Eschwege/Werra (DE)

(72) Inventors: Jörg Schieke, Erfurt-Marbach (DE); Walter Holderbein, Eschwege (DE); Jörg Reinhardt, Berka v.d.H. (DE)

(21) Appl. No.: 17/587,502

(22) Filed: Jan. 28, 2022

(30) Foreign Application Priority Data
Jan. 29, 2021 (DE) 10 2021 102 098.0

(51) Int. Cl. B23F 1/06

(52) U.S. Cl. CPC B23F 1/06

(57) ABSTRACT

The present invention relates to a tool and a method for creating back tapers at an internal or external toothing of a gear. The tool rotates during use about a tool axis of rotation includes a tool shaft extending along the tool axis of rotation, a fastening section for fastening the tool to a tool drive of a machine tool, the fastening section formed at an end of the tool shaft, and at least one cutting blade, which is arranged at a fastening position provided at the circumference of the tool shaft. The tool according to the invention and the method according to the invention enable with simple means the creation of geometrically precisely shaped back tapers at toothings without the need for the use of specially shaped cutting inserts or a change of machine tools proven in practice for the creation of back tapers. This is achieved according to the invention in that the diameter of the tool shaft measured in a plane oriented normal to the tool axis of rotation increases starting from the diameter, which the tool shaft has at the fastening position of the cutting blade, in a direction directed towards the fastening section.

### CROSS-REFERENCE TO RELATED APPLICATION

This application claims priority to German Patent Application No. 10 2021 102 098.0 filed Jan. 29, 2021, the disclosure of which is hereby incorporated by reference in its entirety.

### BACKGROUND OF THE INVENTION

### Field of the Invention

The invention relates to a tool for creating back tapers at an internal or external toothing of a gear, wherein the tool rotating during use about a tool axis of rotation comprises a tool shaft extending along the tool axis of rotation, a fastening section for fastening the tool to a tool drive of a machine tool, the fastening section formed at an end of the tool shaft, and at least one cutting blade, which is arranged at a fastening position provided on the circumference of the tool shaft.

### Description of Related Art

The invention also relates to a method for creating back tapers at the teeth of a toothing of a gear, in which material is removed by chip removal from the flanks of the teeth of the gear rotating about a workpiece axis of rotation by means of at least one cutting blade fastened at the circumference of a tool shaft of a tool rotating about a tool axis of rotation oriented along the tool shaft.

A method as specified at the outset is known from EP 0 550 877 B1. In this method, a single-toothed tool rotating relative to the workpiece on a hypocycloid or epicycloid is pushed into the toothing to be machined. In this case, the respective cycloid movement path of the blade of the tool is selected such that the cycloid branch immersing in the toothing to be machined at least approximately coincides with the pressure angle of the toothing to be machined. In the practical implementation of this method, a tool is used that comprises a slim tool shaft, at the circumference of which two cutting blades arranged offset in the axial direction to one another are arranged in order to simultaneously form an back taper on the front and rear edge of the respective tooth of the toothing to be machined. The tool shaft is clamped with its one end section in a tool clamping of the respective machine tool such that it protrudes free of the clamping over a substantial part of its length carrying the cutting blades. In particular when machining wide workpieces, this clamping can cause the slim tool shaft to bend due to the loads acting on it transversely to the tool axis of rotation. Because of this, in particular in the region of the front back tapers created by the front cutting blades further away from the clamping of the tool, impermissible shaping deviations can be caused. In practice, these shaping deviations can be counteracted by using cutting blades for the creation of the front back tapers, which cutting blades compensate for the shaping deviation of the tool shaft occurring during operation through their special shape adapted to the respective machining task and situation.

A further method for profiling toothed workpieces, in particular for creating back tapers or the like on tooth flanks of internally or externally toothed work wheels, is known from EP 1 644 152 A1. For this purpose, the workpiece rotating about a workpiece axis of rotation is machined by means of a cutting edge tool rotating about a tool axis of rotation, the cutting edge of which meshes with the toothing of the workpiece. Workpiece and cutting edge tool rotate at a fixed speed ratio about their parallel axes of rotation in such a way that the cutting direction is towards the tooth base of the toothing. As a result of a combination overlying the rotational movement of variation of the axial distance and variation of the phase position or the inclination of the axial position on a curve corresponding to the profile shape, the cutting edge tool is thereby displaced. At the same time, the cycloidal movement path of the cutting edge defined by the axial distance, the flight circle of the cutting edge and the transmission ratio is selected relative to the workpiece such that the approaching branch of a cycloidal loop cuts the returning branch of the same cycloidal loop.

Against the background of the prior art explained above, the object has emerged to create a tool with simple means and to specify a method that enable the creation of geometrically precisely shaped back tapers at toothings without the need for the use of specially shaped cutting inserts or a change of machine tools proven in practice for the creation of back tapers.

In order to achieve this object, the invention proposes a tool that comprises at least the features as described herein and a method, in which at least the work steps specified as described herein are carried out.

Advantageous embodiments of the invention are indicated in the dependent claims and, like the general concept of the invention, are explained in detail in the following.

### SUMMARY OF THE INVENTION

A tool according to the invention for creating back tapers at an internal or external toothing of a gear, rotating about a tool axis of rotation, thus comprises, in accordance with the prior art described at the outset, a tool shaft extending along the tool axis of rotation, a fastening section for fastening the tool to a tool drive of a machine tool, the fastening section formed at an end of the tool shaft, and at least one cutting blade, which is arranged at a fastening position provided at the circumference of the tool shaft.

According to the invention, in the case of such a tool, the diameter of the tool shaft measured in a plane oriented normal to the tool axis of rotation increases starting from the diameter, which the tool shaft has at the fastening position of the cutting blade, in a direction towards the fastening section.

A tool according to the invention therefore no longer has an elongated, slim or pin-shaped shape, but is thickened starting at least at least from the position, at which a cutting plate is fastened to the tool shaft, in a direction towards the fastening section. By this thickening increasing in the direction of the fastening section an rigidity of the tool shaft increasing from the fastening position in the direction of the fastening section is achieved, which counteracts precisely the bending loads that occur when the tool is in use. By the geometry according to the invention and the associated mass and strength distribution of the tool it is ensured that the tool, also under the loads occurring during use, is deformed at most within permissible tolerances. As a result, an optimally precise work result can be ensured when creating back tapers at teeth of the toothing of a gear without the need for a complex shaping of the tool or elaborate machine control.

A particular advantage of the design of a tool according to the invention for creating back tapers is also that the diameter in the region of the front section, which adjoins the front surface of the tool that is free during use, can be kept so small that a cutting blade mounted in this region can be brought safely and without problems to the respective machining point even in the spatially limited conditions that are usually present in a machine tool.

Accordingly, an embodiment of the invention that is particularly relevant for practice provides that the distance of the fastening position of the cutting blade to the front side of the tool shaft that is free during use is smaller than the distance of the fastening position to the end of the tool shaft adjoining the fastening section. This means that at least one cutting blade is preferably arranged at the tool shaft in close proximity to the front side of the tool shaft, which is moved during use towards the teeth of the gear workpiece to be machined.

In view of the possibilities of optimal positioning of the cutting blade with respect to the tooth flanks of the teeth of the gear to be machined, it has proven to be particularly advantageous if the fastening position of the cutting blade directly adjoins the front side of the tool shaft that is free during use. This can mean, that, for example, starting from the free front side, a recess is formed into the tool shaft, in which recess the cutting blade is held such that the cutting blade projects laterally beyond the tool shaft in a radial direction and can thus engage with the respective tooth to be machined during use.

If tools according to the invention are equipped with only one cutting blade, back tapers can thus be created at the respectively machined gear, which back tapers adjoin one of the front sides of the gear. If such back tapers are also to be created on the opposite second front side of the gear, the gear is usually turned and then the back tapers are created on the previously unmachined side of the teeth.

However, with a tool according to the invention, back tapers can also be created simultaneously at both ends of the teeth in one run. For this purpose, two fastening positions each for a cutting blade can be provided at the circumference of the tool shaft and, of these two fastening positions, the first fastening position can be arranged at a distance from the front side of the tool shaft that is free during use, which distance is smaller than the distance of the fastening position to the end of the tool shaft adjoining the fastening section, in particular directly adjoins the front side of the tool shaft that is free during use, while the second fastening position is arranged at a distance from the first fastening position in a longitudinal direction of the tool shaft in a direction towards the fastening section. The distance between the fastening positions corresponds to the distance at which the two back tapers are to be created simultaneously at the teeth of the machined gear. In this case, the second fastening position can be provided so far removed from the first fastening position that it directly adjoins the end of the tool shaft assigned to the fastening section.

Due to the fact that the bending deformations, which caused impermissible shape deviations of the back tapers created in the prior art, are avoided with a tool formed according to the invention, a tool according to the invention can be equipped with conventionally designed cutting blades. In this way, a special adjustment is no longer necessary, in particular a special adjustment of those cutting blades that are provided at a fastening position provided in the front region of the tool assigned to the front side of the tool shaft that is free during use.

The cutting blades each carried by a tool according to the invention can be designed in the manner of conventional cutting inserts, so that they can be easily replaced after wear. For this purpose, the respective fastening position can be formed by a recess and the cutting blade arranged in the respective fastening position can be designed as a cutting insert, which is held in the recess with a holding section, while a blade section of the cutting insert projects in a radial direction beyond the circumference of the tool shaft.

It is possible to adapt the increase of the diameter of the tool shaft provided according to the invention precisely to the bending loads actually occurring during use; for example, by detecting the relevant bending loads in a practical test and thus deriving the optimum thickness curve of the tool shaft with respect to the desired stiffening of the tool shaft.

An optimal deformation resistance can be achieved by continuously increasing the diameter of the tool shaft starting from the fastening position of the cutting blade in the direction of the end of the tool shaft assigned to the fastening section. By such a continuous increase in thickness, load jumps and the accompanied stresses in the tool, which could lead to premature failure of the tool, can be prevented.

A particularly practical design of a tool according to the invention based on this results if the tool shaft is shaped at least in sections in the manner of a cone or a truncated cone. Practical tests have shown that such a formed component can not only be manufactured particularly easily, but also guarantees optimised stiffness under the loads resulting in practical use. It has thus been shown that, through a truncated cone or cone shape of the tool shaft, bendings of the tool can always be avoided so reliably that the production accuracy requirements resulting in practical use can be reliably met. The tool designed in this way comprises a conically tapering circumferential surface that, with the axis of rotation of the tool, encloses an angle corresponding to the angle between the tool and the workpiece axis of rotation.

The particular advantage of the tool according to the invention is also that the tool shaft can be easily manufactured as a massive body. The steel materials already proven in the prior art are particularly suitable for this purpose.

According to the above explanations, in a method according to the invention for creating back tapers at the teeth of a toothing of a gear in which material is removed by chip removal from the flanks of the teeth of the gear rotating about a workpiece axis of rotation by means of at least one cutting blade fastened at the circumference of a tool shaft of a tool rotating about a tool axis of rotation oriented along the tool shaft.

According to the invention, a tool designed according to the invention is used for the creation of the back tapers by means of chip removal. Its tool axis of rotation is oriented according to the invention with respect to the workpiece axis of rotation at an angle that is greater than 0°.

In the method according to the invention, the thickness profile of the tool used according to the invention is thus taken into account in that the tool axis and the workpiece axis are oriented at an angle to one another during the creation of the back tapers. The angular orientation of the tool axis of rotation relative to the workpiece axis of rotation compensates that, in the tool according to the invention, the cutting edge of the cutting blade is oriented in the angle β with respect to the tool axis of rotation.

In the particularly practical case that the cutting edge of the cutting blade of the tool according to the invention is oriented parallel to the enveloping of the workpiece shaft, the angle under which the workpiece axis of rotation and the tool axis of rotation intersect is preferably the same as the angle that the surface line determined by the enveloping encloses with the axis of rotation of the tool. Here, the “enveloping” is referred to as the cone surface, which can be created by rotating a straight surface line applied to the tool shaft about the tool axis of rotation.

In this case, the cutting blade thus comprises a cutting edge designed straight-lined at least in sections, wherein the cutting edge is oriented parallel to the surface line, which creates the enveloping of the tool shaft, wherein the angle Σ is set such that the straight-lined section of the cutting edge, at the moment of contact with the tooth to be machined in each case, is oriented parallel to the head surface of the respective tooth of the gear.

In the creation of back tapers according to the invention, the axes of rotation of the tool and workpiece thus meet at an axis-crossing angle, as is also known, for example, from hob peeling and related methods. Due to the arrangement of the axes of rotation at an angle relative to one another, it is possible for the tool, despite the diameter becoming larger in the direction of the tools' fastening section coupled to the tool rotary drive of the respective machine tool, to approach the teeth of the gear to be machined without collision so far that the at least one cutting blade reaches the tooth to be machined by the cutting blade in each case.

In practice, shaping of the tool shaft of a tool according to the invention has proven itself in which an angle β of 4° to 16° results between the surface line of the tool shaft and the tool axis of rotation and thus also between the tool axis of rotation and the workpiece axis of rotation when carrying out the method according to the invention.

A particularly practical embodiment of the method according to the invention results when the cutting blade comprises a cutting edge designed straight-lined at least in sections, which is oriented parallel to a surface line enveloping the tool shaft, wherein the angle β is set such that the straight-lined section of the cutting edge, at the moment of contact with the tooth to be machined in each case, is oriented parallel to the head surface of the respective tooth of the gear.

The tool according to the invention and the method according to the invention do not require any special requirements for the methodical performance of the creation of back tapers at the respectively machined gear except for the specification of the orientation of the axes of rotation of the tool and workpiece at an angle to one another according to the invention. Thus, the ratio of the rotational speeds of tool and workpiece for machining can be set in a known manner such that all teeth of the gear are machined in a single machining run. For this purpose, the rotational speeds can be selected so that they do not have a common divisor. In this case, the geometry of the tool with respect to the geometry of the gear to be machined can be selected such that the flight path of the cutting edges of the respective cutting blade of the tool describes an “open” or a “closed cycloid” movement path.

### BRIEF DESCRIPTION OF THE DRAWINGS

The invention is explained in more detail in the following with reference to a drawing representing an exemplary embodiment. The schematic drawings show:

FIG. 1 a tool when creating back tapers at the teeth of an externally toothed gear in a lateral view;

FIG. 2 the tool according to FIG. 1 in a frontal view;

FIG. 3 the tool according to FIGS. 1 and 2 in a perspective view from behind;

FIG. 4 an alternative design of a tool for creating back tapers in a lateral view.

### DESCRIPTION OF THE INVENTION

The tool 1 for creating back tapers H at the external toothing A of a gear ZR rotates about a tool axis of rotation W during use.

In this case, the tool 1 comprises a tool shaft 4 extending along the tool axis of rotation W, on an end 5 of which a conventionally designed fastening section 6 for fastening the tool 1 to a clamping of a tool drive, not shown here for the sake of clarity, of a machine tool, also not shown, is formed. The tool shaft 4 and the fastening section 5 are made massively from a piece from a tool steel proven in the prior art for the manufacture of tools of the type in question here.

At its end opposite to the fastening section 6 and protruding freely from the clamping of the tool drive during use, the tool shaft 4 comprises a front side 7, which has a circular basic shape with a diameter D1. Starting from the front side 7, the diameter D of the tool shaft 4 increases continuously in the direction of the longitudinal direction L of the tool shaft 4 extending parallel to the tool axis of rotation W until the end 5 of the tool shaft 4 assigned to the fastening section 6 is reached at which the diameter D has its greatest value D2.

In this way, the tool shaft 4 has the shape of a truncated cone, the circumferential surface 8 of which is represented by rotation of a straight surface line M about the tool axis of rotation W and thus proceeds from its thickest point adjoining the fastening section 6 conically in the direction of the front side 7 of the tool shaft 4 that is free during use.

The surface line M is thereby inclined relative to the tool axis of rotation W by an angle β of 5°, for example.

Starting from the front side 7, a recess 9 opened laterally towards the circumferential surface 8 is formed into the tool shaft 4, in which recess 9 a conventionally designed cutting blade insert 10 sits with its holding section. The holding section of the cutting blade insert 10 carries a cutting blade 11, which protrudes freely in the radial direction R beyond the circumferential surface 8 of the tool shaft 4. In this way, the cutting blade 11 is held at a fastening position B1 which directly adjoins the front side 7 of the tool shaft 4 that is free during use and thus has the greatest possible distance S to the end 5 of the tool shaft 4 adjoining the fastening section 7. The cutting blade 11 comprises a straight-lined cutting edge 12, which in the example described here extends parallel to the circumferential surface 8 of the tool shaft 4.

In use, the gear ZR rotates synchronously with the tool 1 about a tool axis of rotation W. The rotational speed ratio R1/R2 of the rotational speed R1 at which the tool 1 rotates about the tool axis of rotation W to the rotational speed R2 at which the workpiece (gear ZR) rotates about its workpiece axis of rotation X is selected such that both rotational speeds R1, R2 do not have a common divisor. In this manner, it is achieved in a known manner that all teeth Z of the gear ZR are evenly machined after a sufficient number of circulations.

In order to create the back tapers H at the teeth Z of the external toothing A of the gear ZR, the tool 1 with its tool axis of rotation W is positioned relative to a workpiece axis of rotation X such that, between the workpiece axis of rotation X and the tool axis of rotation W, an axis-crossing angle Σ is enclosed, which is, for example, the same as the angle β about which the surface line M representing the circumferential surface 8 of the conical tool shaft 4 is oriented with respect to the tool axis of rotation W.

In this way, the circumferential surface 8 of the tool shaft 4 is oriented at the point of its greatest approach to the workpiece axis of rotation X parallel to the workpiece axis of rotation X. As a result, the cutting edge 12 of the cutting blade 11, at the moment of engagement in the respective tooth Z to be machined, is also oriented parallel to its head surface K and thus parallel to the workpiece axis of rotation X.

In this way, despite the conicity of the tool shaft 4 and the cutting edge 12 of the cutting blade 11 oriented parallel to the circumferential surface 8 of the tool shaft 4, a cutting pattern is created during the chip-removing creation of the back tapers H on the teeth Z of the gear ZR performed by the cutting blade 11, which cutting pattern corresponds to that which results when back tapers are introduced into the teeth of a gear with a slim tool of the type mentioned at the outset and described in EP 0 550 877 B1, but which is susceptible to deformation.

In contrast to the prior art, in which slim tools have to be used in order to reach the place where the respective back taper is to be created, in the tool 1 according to the invention the risk of a bending deformation along its tool axis of rotation W is minimized in that the tool shaft 4, due to its increasing thickness starting from the fastening position B1 in the direction towards the fastening section 6, offers a high resistance to deformation to the forces that occur during the engagement of the cutting blade 11 into the material of the teeth Z of the gear ZR and are oriented transversely to the tool axis of rotation W.

As a result, high-precision production of the back tapers H at the gear ZR is also enabled if the fastening position B1 for the cutting blade 11 is selected to protrude widely freely with respect to the fastening section 6 with which the tool 1 is held in the tool recess of the respective machine tool during use.

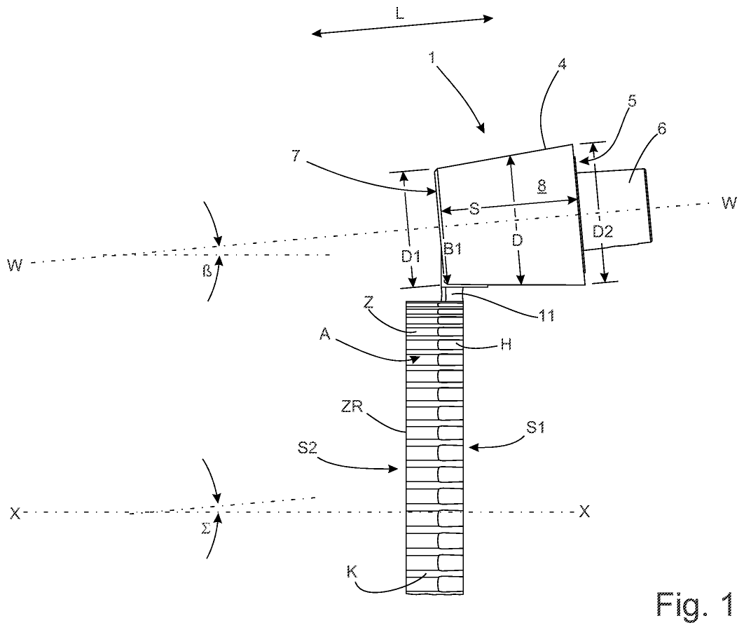

If back tapers H at the gear ZR are not only to be created at the end sections of the teeth Z with the tool 1, which end sections are assigned to the one front side S1 of the gear ZR, but also at the end sections adjoining the opposite front side S2, then for this purpose, in FIG. 1, the tool 1 can be turned about a vertical axis V as soon as the creation of the back tapers H adjoining the first front side S1 is completed, and a further machining run can be performed with the tool 1.

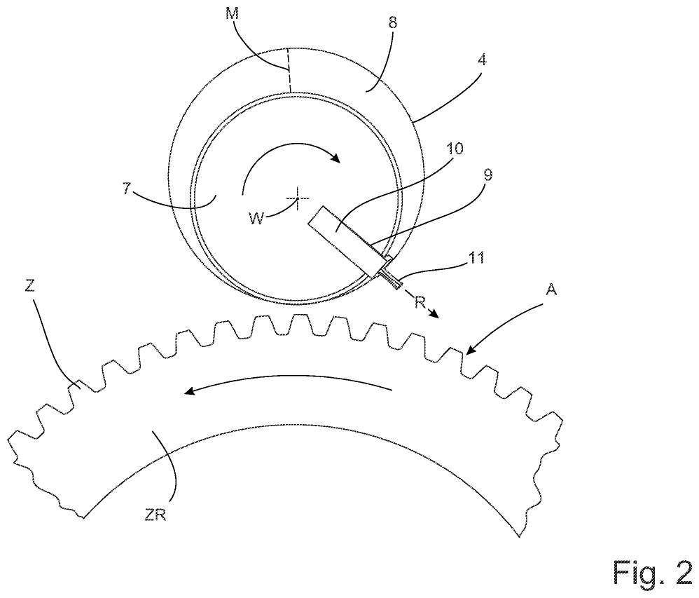

FIG. 2 shows an example of a tool 101 that enables the simultaneous creation of back tapers H1, H2 at the front sided S1, S2 of the gear ZR to be machined.

For this purpose, the tool 101 has a tool shaft 104 and a fastening section 106, which are shaped in one piece as a massive body in the manner described above for the tool 1.

As with the tool 1, a recess is also formed into the tool 101 in its front side 107 that is free during use, which recess, like the recess 9 of the tool 1, is open in the radial direction R to the circumferential surface 108 of the tool 101. A conventionally shaped first cutting blade insert 110 sits in the recess. The cutting blade 111 of the cutting blade insert 110 is located in the tool 101 at the same fastening position B1 as the cutting blade 11 in the tool 1. Here too, the cutting edge of the cutting blade 111 is oriented parallel to the axis of rotation W of the tool 101.

Additionally, a second cutting blade 113 is provided with the tool 101. For this purpose, at a fastening position B2, which is provided approximately in the middle of the longitudinal extension of the tool shaft 104, a recess is formed into the circumferential surface 108 of the tool 101 in which recess a cutting blade insert 114 sits. Like the cutting blade inserts 10 and 110, the cutting blade insert 114 carries the second cutting blade 113 projecting in the radial direction R beyond the circumferential surface 108 of the conically shaped tool shaft 104.

For machining the gear ZR, the tool 101, like the tool 1, is oriented with its axis of rotation W with respect to the axis of rotation X of the gear ZR rotating synchronously with the tool 101 under the axis-crossing angle Σ and positioned such that the cutting blades 110 and 113 engage with the respective tooth Z to be machined. Here too, the conical shape of the tool shaft 104, which increases in thickness starting from the front side 107 that is free during use, ensures that no deformations of the tool 101 occur during machining, despite the transverse loads of the tool 101 occurring thereby, which deformations could impair the precision of the machining result.

### REFERENCE NUMERALS

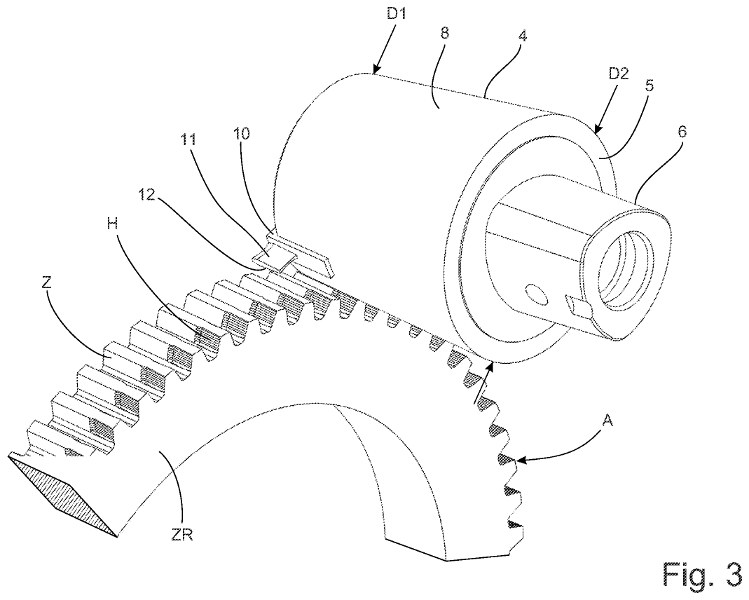

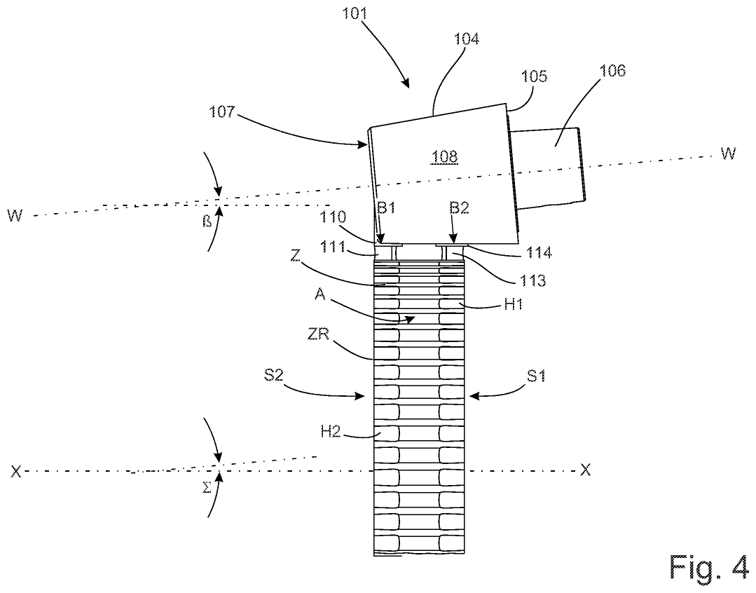

1 Tool for creating the back tapers H
4 Tool shaft
5 End of the tool shaft 4 assigned to the fastening section 6
6 Fastening section
7 Front side 7 of the tool shaft 4 that is free during use
8 Circumferential surface of the tool shaft 4
9 Recess
10 Cutting blade insert
11 Cutting blade of the cutting blade insert 10
12 Cutting edge of the cutting blade 11
101 Tool for simultaneous creation of back tapers H1, H2
104 Tool shaft
105 End of the tool shaft 104 assigned to the fastening section 106
106 Fastening section
107 Front side of the tool shaft 104 that is free during use
108 Circumferential surface of the tool 101
110 Cutting blade insert
111 Cutting blade of the cutting blade insert 110
113 Second cutting blade
114 Second cutting blade insert
β Inclination angle of the surface line M relative to the tool axis of rotation W
Σ Axis-crossing angle
A External toothing of the gear ZR
B1 Fastening position of the cutting blade 11 (FIGS. 1 to 3) and the cutting blade 111 (FIG. 4)
B2 Fastening position of the second cutting blade 113 (FIG. 4)
D Diameter of the tool shaft 4
D1 Diameter of the tool shaft 4 at its front side 7
D2 Diameter of the tool shaft 4 at its end 5
H Back taper
H1, H2 Back tapers
K Respective head surface of the teeth Z
L Longitudinal direction
M Surface line creating the circumferential surface 8
R Radial direction
S Distance
S1, S2 Front sides of the gear ZR to be machined
W Tool axis of rotation
X Workpiece axis of rotation
z Teeth of the gear ZR
ZR Gear

1. A tool for creating back tapers at an internal or external toothing of a gear, wherein the tool rotating during use about a tool axis of rotation comprises a tool shaft extending along the tool axis of rotation, a fastening section for fastening the tool to a tool drive of a machine tool, the fastening section formed at an end of the tool shaft, and at least one cutting blade, which is arranged at a fastening position provided at the circumference of the tool shaft, wherein the diameter of the tool shaft measured in a plane oriented normal to the tool axis of rotation increases starting from the diameter, which the tool shaft has at the fastening position of the cutting blade, in a direction directed towards the fastening section.

2. The tool according to claim 1 wherein the distance of the fastening position of the cutting blade to the front side of the tool shaft that is free during use is smaller than the distance of the fastening position to the end of the tool shaft adjoining the fastening section.

3. The tool according to claim 2, wherein the fastening position of the cutting blade directly adjoins the front side of the tool shaft that is free during use.

4. The tool according to claim 2, wherein two fastening positions each for a cutting blade are provided at the circumference of the tool shaft and in that of these two fastening positions, the first fastening position is arranged according to claim 2, while the second fastening position is arranged spaced apart from the first fastening position in a longitudinal direction of the tool shaft in a direction towards the fastening section.

5. The tool according to claim 4, wherein the second fastening position directly adjoins the end of the tool shaft assigned to the fastening section.

6. The tool according to claim 1, wherein the respective fastening position is formed by a recess and the cutting blade arranged in the respective fastening position is designed as a cutting insert, which is held in the recess with a holding section, while a cutting blade of the cutting insert projects in a radial direction beyond the circumference of the tool shaft.

7. The tool according to claim 1, wherein the diameter of the tool shaft continuously increases starting from the fastening position of the cutting blade in a direction towards the end of the tool shaft assigned to the fastening section.

8. The tool according to claim 7, wherein the diameter of the tool shaft continuously increases starting from the front side of the tool shaft that is free during use in a direction towards the end of the tool shaft assigned to the fastening section.

9. The tool according to claim 7, wherein the tool shaft is shaped at least in sections in the manner of a cone or a truncated cone.

10. The tool according to claim 1, wherein the tool shaft is manufactured as a massive body.

11. A method for creating back tapers at the teeth of a toothing of a gear, in which material is removed by chip removal from the flanks of the teeth of the gear rotating about a workpiece axis of rotation by means of at least one cutting blade fastened at the circumference of a tool shaft of a tool rotating about a tool axis of rotation oriented along the tool shaft, wherein the tool is designed according to claim 1 and in that the tool axis of rotation is oriented with respect to the workpiece axis of rotation at an angle Σ greater than 0°.

12. The method according to claim 11, wherein the angle Σ, at which the tool axis of rotation and the workpiece axis of rotation are arranged angularly with respect to one another, is at least equal to an angle β that a surface line, which is applied to the tool shaft and forms the enveloping of the tool shaft, encloses with the tool axis of rotation

13. The method according to claim 11, wherein the angle β is 4° to 16°.

14. The method according to claim 11, wherein the cutting blade comprises a cutting edge designed straight-lined at least in sections, which is oriented parallel to the surface line, which creates the enveloping of the tool shaft, and in that the angle Σ is set such that the straight-lined section of the cutting edge, at the moment of contact with the tooth to be machined in each case, is oriented parallel to the head surface of the respective tooth of the gear.
